(19) United States
(12) Patent Application Publication
(10) Pub. No.: US 2023/0299375 A1
(43) Pub. Date: Sep. 21, 2023

(54) DATA CENTER BATTERY CLUSTER WITH IMMERSION SYSTEM

(71) Applicant: Baidu USA LLC, Sunnyvale, CA (US)

(72) Inventor: Tianyi GAO, San Jose, CA (US)

(21) Appl. No.: 17/699,727

(22) Filed: Mar. 21, 2022

(51) Int. Cl. H01M 10/627; H01M 10/6557; H01M 50/251; H01M 10/48; H01M 10/63

(52) U.S. Cl. CPC H01M 10/627; H01M 10/486; H01M 10/63; H01M 10/6557; H01M 50/251; H01M 2220/10

(57) ABSTRACT

Embodiments are disclosed of a battery package. The battery package includes one or more battery compartments each having an upstream end, a downstream end, and a plurality of sidewalls extending between the upstream end and the downstream end. Each battery compartment has a plurality of battery cells disposed therein. A supply module is fluidly coupled to the upstream end of the one or more battery compartments. The supply module includes a supply pump having an inlet and an outlet, and a supply flow channel that fluidly couples the outlet of the supply pump to the upstream ends of the one or more battery compartments.

### TECHNICAL FIELD

The disclosed embodiments relate generally to battery backup units (BBUs) for information technology (IT) equipment and more specifically, but not exclusively, to a cooling system for BBUs.

### BACKGROUND

Modem data centers like cloud computing centers house enormous amounts of information technology (IT) equipment such as servers, blade servers, routers, edge servers, power supply units (PSUs), battery backup units (BBUs), etc. These individual pieces of IT equipment are typically housed in racks within the computing center, with multiple pieces of IT equipment in each rack. The racks are typically grouped into clusters within the data center.

The main power source for IT equipment in each rack is generally a facility power source, such as electricity provided to the data center by an electrical utility. BBUs, as their name implies, are intended to provide backup power to IT equipment in a rack when the main power source fails or must be taken offline for maintenance, or in other scenarios such as during peak power usage. When a BBU is providing power to IT equipment in a rack, energy storage units in the BBU, e.g. batteries, are discharging. When they are not providing power to the IT equipment the batteries are either idle (i.e., neither charging nor discharging) or are being charged by the main power source. Charging and discharging the batteries generates heat, meaning that at times batteries in a BBU can require cooling. Battery heating becomes more problematic as the power consumption of IT equipment in the rack increases: higher energy consumption requires a higher battery discharge rate that generates more heat, and faster battery charging similarly generates more heat. Existing cooling solutions for battery packs rely on air cooling or liquid cooling, but these solutions might not enable high power density and high packaging densities. In addition, there is currently no mature design for backup battery packs with single phase coolant for data center applications.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Non-limiting and non-exhaustive embodiments of the present invention are described with reference to the following figures, wherein like reference numerals refer to like parts throughout the various views unless otherwise specified.

FIGS. 1A-1C are schematic views of an embodiment of a battery package. FIG. 1A is an exploded top view of the module, FIG. 1B a top view of an assembled module, and FIG. 1C a sectional side view of the assembled module taken substantially along section line C-C in FIG. 1B.

FIGS. 2A-2C are schematic top views of other embodiments battery packages.

FIG. 3 is a schematic top or side view of an embodiments of a high-density grouping of battery packages.

FIGS. 4A-4B are schematic views of an embodiment of a battery cooling system. FIG. 4A is a top view, FIG. 4B a sectional side view taken substantially along section line B-B in FIG. 4A.

FIG. 5 is a schematic top view of another embodiment of a battery cooling system.

FIG. 6 is a flowchart of an embodiment of the operation of a battery cooling system such as those shown in FIGS. 4A-4B and 5.

### DETAILED DESCRIPTION

Embodiments are described of a battery packages and their use in a battery cooling system for an information technology (IT) enclosure. Specific details are described to provide an understanding of the embodiments, but one skilled in the relevant art will recognize that the invention can be practiced without one or more of the described details or with other methods, components, materials, etc. In some instances, well-known structures, materials, or operations are not shown or described in detail but are nonetheless encompassed within the scope of the invention.

Reference throughout this specification to “one embodiment” or “an embodiment” means that a described feature, structure, or characteristic can be included in at least one described embodiment, so that appearances of “in one embodiment” or “in an embodiment” do not necessarily all refer to the same embodiment. Furthermore, the described features, structures, or characteristics can be combined in any suitable manner in one or more embodiments. As used in this application, directional terms such as “front,” “rear,” “top,” “bottom,” “side,” “lateral,” “longitudinal,” etc., refer to the orientations of embodiments as they are presented in the drawings, but any directional term should not be interpreted to imply or require a particular orientation of the described embodiments when in actual use.

The present application discloses embodiments of a cooling solution for battery backup units that include clusters of battery cells. The described embodiments enable active liquid cooling for battery cells that have different thermal management requirements under different operation scenarios. The embodiments aim to provide more effective and optimized cooling for battery backup units in data centers. The disclosed embodiments provide a solution for designing and packaging battery packages and their enclosures for data center clusters. The described embodiments can provide effective and efficient immersion cooling systems, including the hardware design and control system for managing battery package operations. In addition, the disclosed embodiments enable some or all of the following benefits:
High power density energy units for backup power application.
High efficiency single phase coolant management.
Efficient control design and implementation.
Enhancing battery cell reliability.
Ease of implementation.
Ease of service and maintenance.
Accommodate different server and IT systems and different backup power requirements.
High scalability.
Modular hardware design.
Advanced control for system robustness.
Enhancing battery cell performance.

The disclosed embodiments can be used to develop thermal management systems for battery pack using single-phase cooling. The embodiments provide more robust operation and management for overall battery systems and their thermal systems. The embodiments include co-designing the battery package and the battery enclosure. A battery enclosure is populated and integrated with one or more battery packages and provides a management system for the battery packages. The battery packages are used for packaging multiple battery cells and include one or more fluid pumps packaged internally, with the pump fully integrated with a battery compartment or chassis. The chassis includes an upstream end connected to the battery compartment and to a supply module with the pump. The supply module includes the pump and other electrically connected active parts. The battery cells and the pump can be operated, charged, discharged, and controlled in a synchronized mode.

In one aspect, a battery package includes one or more battery compartments, each having an upstream end, a downstream end, and a plurality of sidewalls extending between the upstream end and the downstream end. Each battery compartment has a plurality of battery cells disposed therein. A supply module is fluidly coupled to the upstream end of the one or more battery compartments, with the supply module including a supply pump having an inlet and an outlet, and a supply flow channel that fluidly couples the outlet of the supply pump to the upstream ends of the one or more battery compartments.

In one embodiment, a supply valve is fluidly coupled to the inlet or the outlet of the supply pump, a return valve positioned at the downstream end of the one or more battery compartments; or a supply valve fluidly coupled to the inlet or the outlet of the supply pump and a return valve positioned at downstream end of the one or more battery compartments. In one embodiment the supply flow channel is a diverging flow channel.

In another embodiment the battery package further includes a return module with a return flow channel fluidly coupled to the downstream ends of the one or more battery compartments. In one embodiment the return module further comprises a return pump having an inlet and an outlet, the inlet of the return pump being fluidly coupled to the return flow channel, and in an embodiment the return flow channel is a converging channel.

In another embodiment the battery package further includes one or more additional battery compartments each having an upstream end, a downstream end, and a plurality of sidewalls extending between the upstream end and the downstream end, each additional battery compartment having a plurality of battery cells disposed therein. In an embodiment an additional supply module is fluidly coupled to the upstream end of each additional battery compartment. The supply module includes a supply pump having an inlet and an outlet and a supply flow channel that fluidly couples the outlet of the supply pump to the upstream ends of the one or more additional battery compartments. The inlet of the supply pump of the additional supply module is fluidly coupled to an outlet of the return flow channel.

In another embodiment the battery package further includes an electrical bus electrically coupled to the plurality of battery cells and communicatively coupled to the supply pump. A charge/discharge sensor is coupled to the electrical bus to sense when the plurality of battery cells is charging or discharging, and a controller is electrically coupled to the charge/discharge sensor and the supply pump, so that the controller can direct electricity from the electrical bus to the supply pump when the plurality of battery cells is charging or discharging. In another embodiment, the battery package further includes a temperature sensor positioned at or near the downstream ends of the one or more battery compartments and a controller electrically coupled to the temperature sensor and the supply pump. The controller can regulate the speed of the supply pump based on the temperature sensed by the temperature sensor.

In another aspect, a battery cooling system includes a container including a container supply channel, a container return channel, and a battery space. One or more battery packages are positioned in the battery space, each battery package including one or more battery compartments each having an upstream end, a downstream end, and a plurality of sidewalls extending between the upstream end and the downstream end. Each battery compartment has a plurality of battery cells disposed therein. A supply module is fluidly coupled to the upstream end of the one or more battery compartments. The supply module includes a supply pump having an inlet and an outlet, and a supply flow channel that fluidly couples the outlet of the supply pump to the upstream ends of the one or more battery compartments. The inlet of each supply pump is fluidly coupled to the container supply channel and the downstream ends of the one or more battery compartments are fluidly coupled to the container return channel.

In one embodiment, each battery package further includes a supply valve fluidly coupled to the inlet or the outlet of the supply pump, a return valve positioned at the downstream end of the one or more battery compartments, or a supply valve fluidly coupled to the inlet or the outlet of the supply pump and a return valve positioned at downstream end of the one or more battery compartments.

In one embodiment each battery package further comprises a return module that includes a return flow channel fluidly coupled to the downstream ends of the one or more battery compartments. The downstream ends of the one or more battery compartments are fluidly coupled by the return flow channel to the container return channel. In another embodiment each return module further includes a return pump having an inlet and an outlet. The inlet of the return pump is fluidly coupled to the return flow channel and the outlet of the return pump is fluidly coupled to the container return channel.

In one embodiment the battery cooling system includes a container power bus electrically coupled to a utility and to the battery cells and the supply pumps of the one or more battery packages. In another embodiment, the battery cooling system includes a central power unit electrically coupled to the container power bus and communicatively coupled to the supply pumps of the one or more battery packages. The central power unit is adapted to cause the battery cells to deliver electrical power to the container power bus when the battery cells are discharging and cause the utility to deliver electrical power to the container power bus when the battery cells are charging, and is also adapted to selectively activate, deactivate, or regulate the supply pump of at least one of the one or more battery packages.

In another embodiment each battery package further includes an electrical bus electrically coupled to the plurality of battery cells and communicatively coupled to the supply pump. A charge/discharge sensor is coupled to the electrical bus to sense when the plurality of battery cells are charging or discharging, and a controller is electrically coupled to the charge/discharge sensor and the supply pump. The controller can direct electricity from the electrical bus to the supply pump when the plurality of battery cells is charging or discharging.

In another embodiment each battery package further includes a temperature sensor positioned at or near the downstream ends of the one or more battery compartments and a controller electrically coupled to the temperature sensor and the supply pump, wherein the controller can regulate the speed of the supply pump based on the temperature sensed by the temperature sensor.

In another embodiment the battery cooling system further includes a battery space pump to push cooling fluid into the battery space and a battery space outlet to pull cooling fluid from the battery space. Yet another embodiment further includes a container supply pump to push cooling fluid into the container supply channel and a return channel outlet to pull cooling fluid from the return channel. In another embodiment the one or more battery packages are fluidly connected to the container supply channel by fluid lines and fluid connectors.

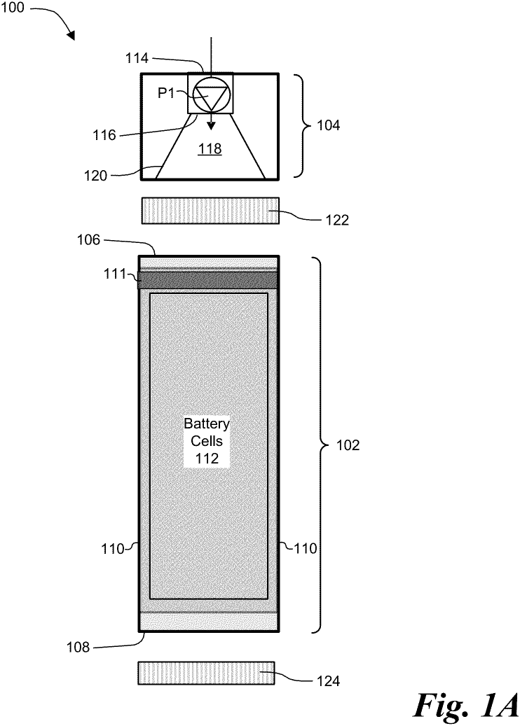

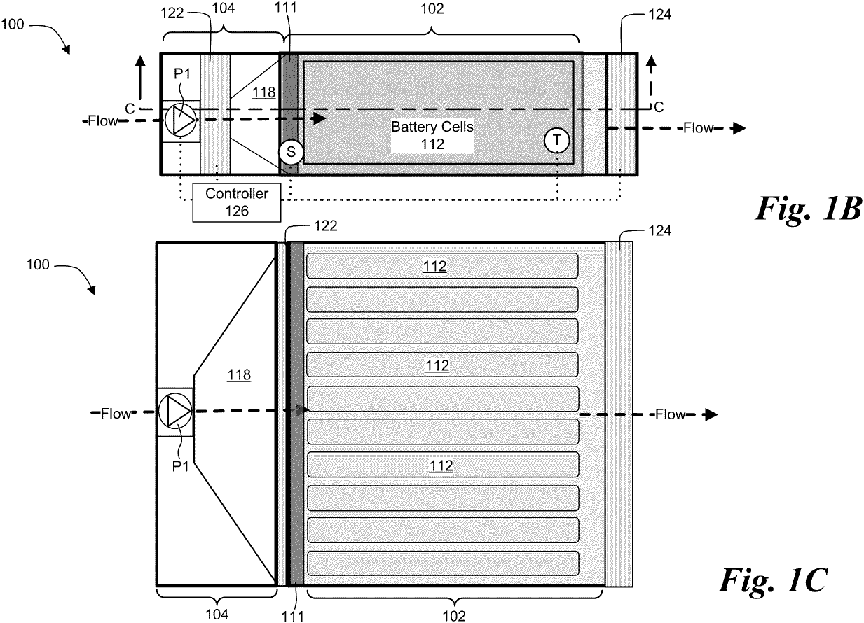

FIGS. 1A-1C together illustrate an embodiment of a battery package 100. FIG. 1A is an exploded top view of the module, FIG. 1B is a top view of the assembled module, and FIG. 1C is a sectional side view of the assembled module taken substantially along section line C-C in FIG. 1B. Battery package 100 includes two primary components: a battery compartment 102 and a supply module 104.

Battery compartment 102 has an upstream side 106, a downstream side 108, and a sidewall 110 that forms a battery chassis and extends between the upstream side and the downstream side. In an embodiment where battery compartment 102 is cylindrical and has a quadrilateral cross-section, sidewall 110 can include four planar walls, but in other embodiments sidewall 110 can be structured differently. For instance, in an embodiment where battery compartment 102 is cylindrical with a circular cross-section, sidewall 108 can be a single curved wall. One or more battery packs, each including a plurality of battery cells 112, are positioned in the interior of battery compartment 102. An electrical bus 111 can also be positioned within the battery compartment and electrically coupled to the plurality of battery cells 112. A charge/discharge sensor S (see FIG. 1B) can be electrically coupled to electrical bus 111 to sense when battery cells 112 are charging or discharging. Sensor S can be communicatively coupled to a controller 126, and controller 126 can in turn be communicatively coupled to pump P1, or switching elements within or associated with pump P1, and to valves 122 and/or 124, if present. With this arrangement, sensor S can be used to activate, deactivate, and regulate pump P1 as well as to regulate the open ratios of valves 122 and/or 124.

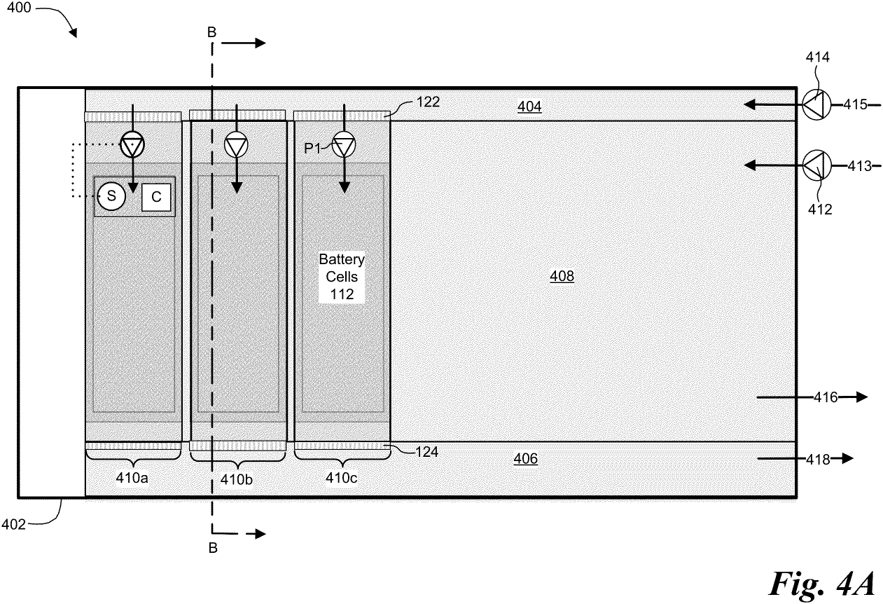

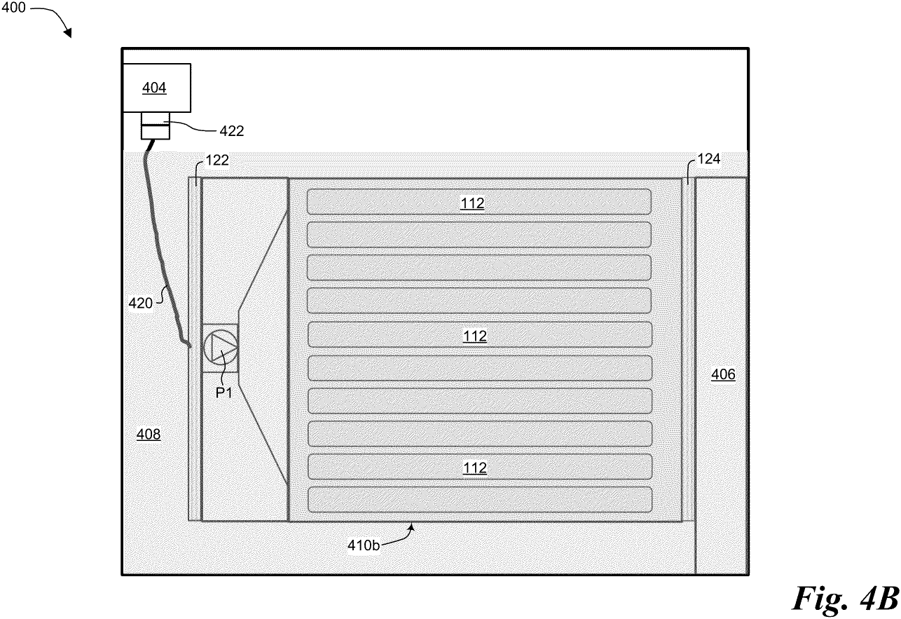

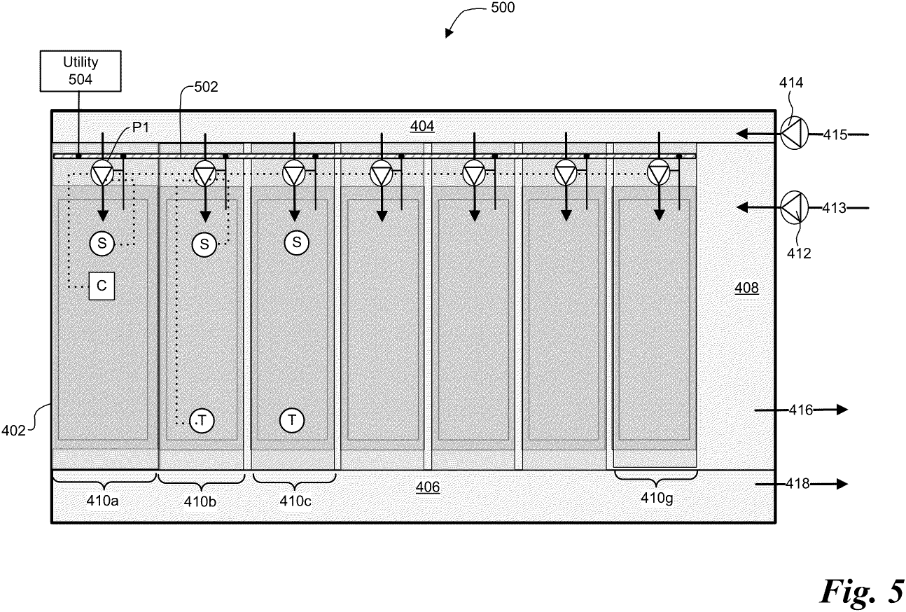

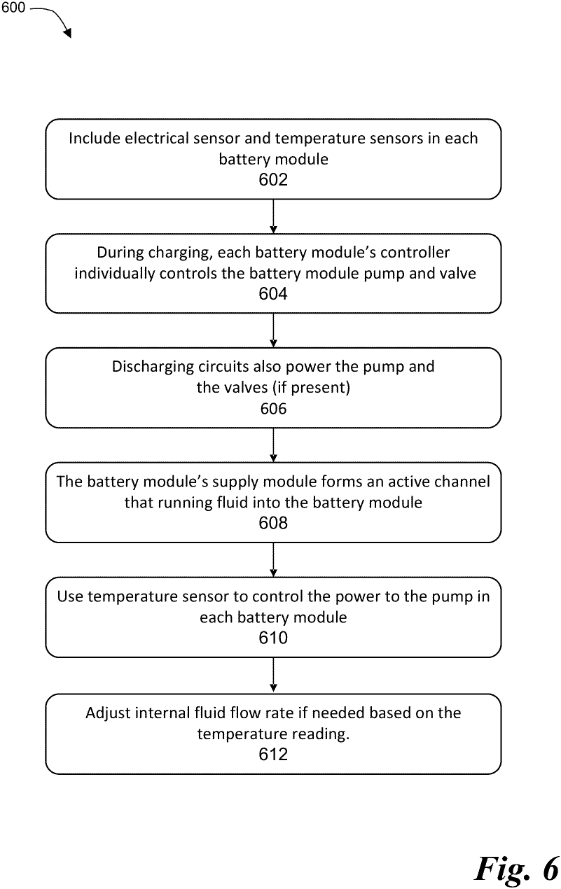

Supply module 104 includes a supply pump P1 having an inlet 114 and an outlet 116. Pump inlet 114 is coupled to a source of cooling fluid (see, e.g., FIGS. 4A-4B and 5) and pump outlet 116 is fluidly coupled to a supply flow channel 118. Supply flow channel 118 is formed by sidewalls 120. In the illustrated embodiment, supply flow channel 118 is a diverging channel (i.e., its cross-sectional area increases in the flow direction), but in another embodiment it could be a converging channel (i.e., its cross-sectional area decreases in the flow direction), or a constant cross-section channel. The size and shape of some part of supply flow channel 118, typically one of its ends, can substantially correspond in size and shape to the upstream end of battery compartment 102 or to the size and shape of the plurality of battery cells 112 within the battery compartment.

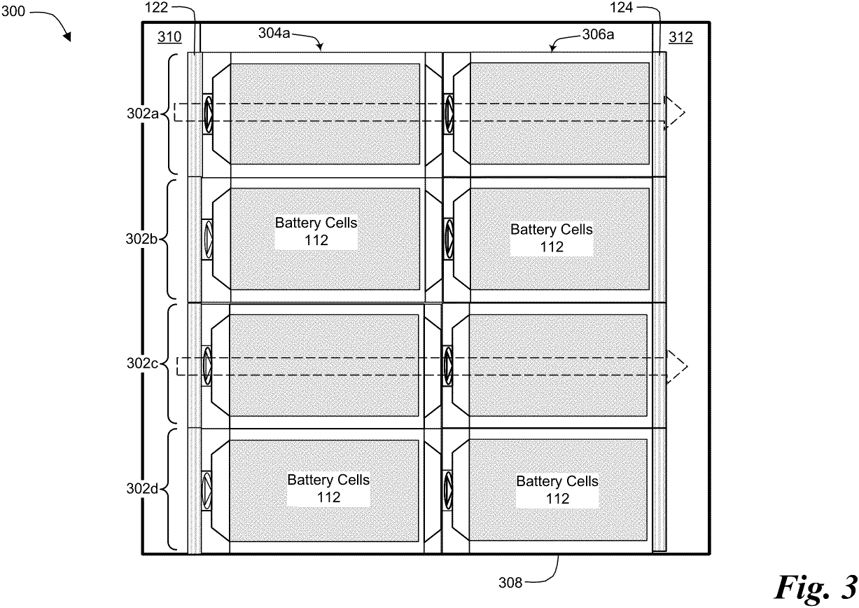

Supply module 104 is fluidly coupled to upstream end 106 of the battery compartment. In some embodiments a valve 122 can be interposed between supply module 104 and upstream end 106, but not all embodiments need include valve 122. In other embodiments a valve 124 can be fluidly coupled to downstream and 108 of the battery compartment, but not all embodiments need include valve 124. In still other embodiments, one or both of valves 122 and 124 can be present but positioned differently than shown. For instance, in some embodiments valve 122 can be positioned upstream of supply module 104, at or before the inlet of pump P1, instead of at the outlet of the supply module (see, e.g., FIGS. 3, 4A-4B, and 5). In an embodiment, valves 122 and 124 are optional valves. In another embodiment, the 122 can be designed as a distribution structure connected to the diverging side of the channel for better fluid distribution.

In operation of battery package 100, the battery package is submerged in an immersion cooling fluid and pump inlet 114 is coupled to a source of immersion cooling fluid (see, e.g., FIGS. 4A-4B and 5). Battery cells 112 normally require cooling only when charging or discharging. In the illustrated embodiment charging/discharging sensor S can sense when battery cells 112 are charging or discharging and, via controller 126, activate supply pump P1 when cooling is required. When battery cells 112 are discharging, controller 126 can also direct electricity from electrical bus 111 to supply pump P1, so that the pump is at least partially operated with electricity from the battery cells. This arrangement also provides some automatic control of supply pump P1: when batteries cells 112 are discharging at their highest rate, and thus generating the most heat, more electricity is sent through bus 111 to supply pump P1 and the pump directs more immersion cooling fluid into the battery compartment and through battery cells 112. As the discharge rate decreases, less electricity and heat are generated and manifold pump P1 pumps less cooling fluid into and through fluid injectors 116.

During operation, the battery package is submerged in an immersion cooling fluid and pump inlet 114 is coupled to a source of immersion cooling fluid (see, e.g., FIGS. 4A-4B and 5). When supply pump P1 begins to operate, it takes in cooling fluid through its inlet and discharges it through its outlet into supply flow channel 118. Supply flow channel 118 in turn distributes cooling fluid from pump outlet 116 into the upstream end 106, where the cooling fluid enters battery compartment 102 and flows over, and extracts heat from, battery cells 112. Having flowed over and extracted heat from the battery cells, the cooling fluid exits battery compartment 102 through downstream end 108. In embodiments where one or both of valves 122 and 124 are present, controller 126 can adjust the open ratio of one or both valves can to start, stop, or regulate flow of cooling fluid through the battery compartment. A valve’s open ratio is a measure of how much fluid the valve lets through. For instance, an open ratio of 0 means that the valve is fully closed and no fluid flows through it, an open ratio of 1 means the valve is fully open and fluid flows through it substantially unimpeded, an open ratio of 0.5 means the valve is half open, etc.

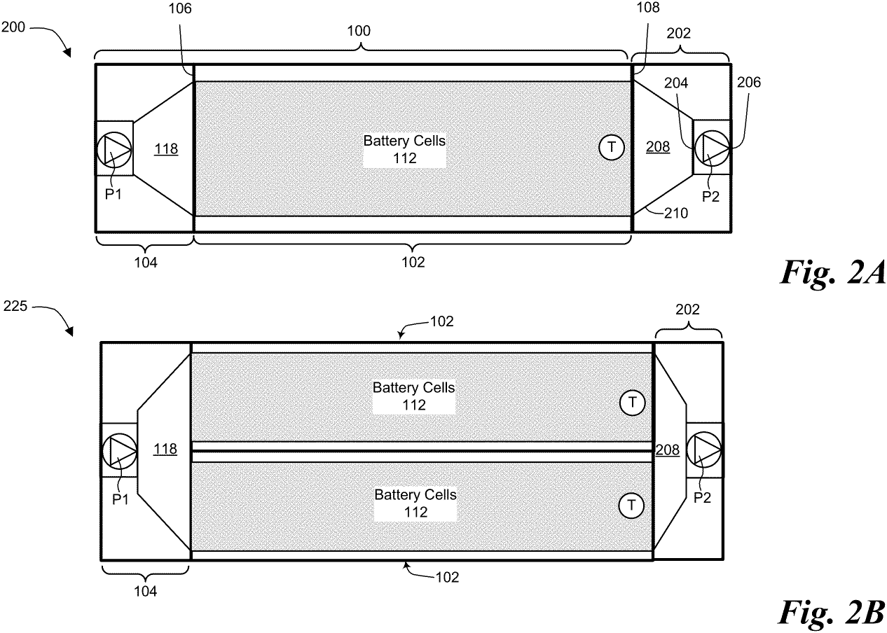

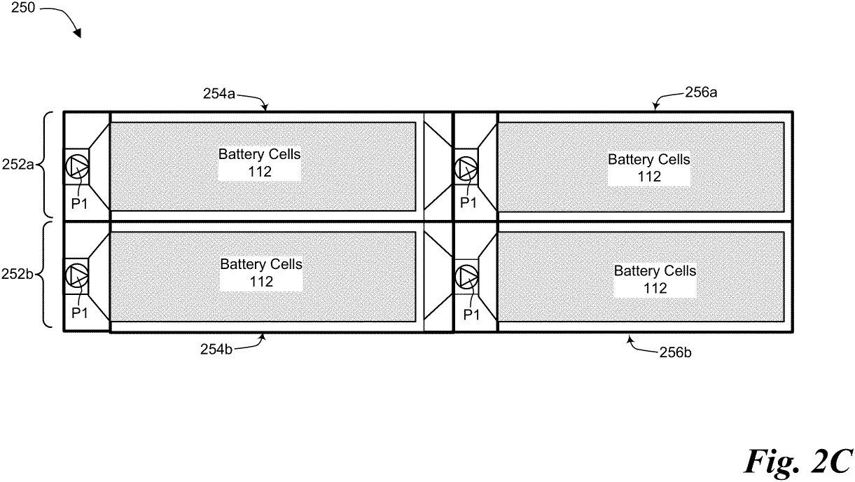

FIGS. 2A-2C illustrate various embodiments of battery packages. FIG. 2A illustrates an embodiment of a battery package 200. Battery package 200 is in most respects similar to battery package 100: it includes a battery compartment 102 and a supply module 104 fluidly coupled to upstream end 106 of the battery compartment. The primary difference between battery packages 200 and 100 is that battery package 200 adds a return module 202 to downstream end 108 of the battery compartment. Valves 122 and 124 of battery package 100 are not shown in battery package 200, but can nonetheless be included if needed.

Return module 202 is in most respects similar to supply module 104: it includes a return pump P2 having an inlet 204 and an outlet 206. Pump inlet 204 is fluidly coupled to a return flow channel 208 that is formed by sidewalls 210. In the illustrated embodiment, return flow channel 208 is a converging channel (i.e., its cross-sectional area decreases in the flow direction), but in another embodiment it could be a diverging channel (i.e., its cross-sectional area increases in the flow direction), or a constant cross-section channel. The size and shape of some part of return flow channel 208, typically one of its ends, can substantially correspond in size and shape to the downstream end of battery compartment 102 or to the size and shape of the plurality of battery cells 112 within the battery compartment. Although not shown in this figure, in battery package 200 battery cells 112 can be electrically coupled to a bus 110, and both pumps P1 and P2 can be powered by electricity from bus 110, as discussed above for battery package 100. Battery compartment 102 can also include a temperature sensor T positioned at or near downstream and 108, so that the temperature sensor measures the temperature of cooling fluid exiting the battery compartment after being heated by battery cells 112. Temperature sensor T can be communicatively coupled to pumps P1 and P2, for instance via a controller 126 as shown for battery package 100, to help control the flow rate and pressure of cooling fluid flowing through battery compartment 102, thus controlling the amount of cooling provided to battery cells 112.

Battery package 200 operates substantially the same way as battery package 100, except that return module 202 and pump P2 provide additional capability to control and manage flow through the battery compartment and thus manage cooling of battery cells 112. Battery package 200, with pumpsP1 and P2 arranged in series and integrated to the module, provides stronger and more defined fluid acceleration through the battery compartment. Use of both supply module 104 and return module 202 also makes it easier to connect multiple battery packages in series (see, e.g., FIGS. 2C and 3).

FIG. 2B illustrates an embodiment of a battery package 225. Battery package 225 is in most respects similar to battery package 200: it includes battery compartment 102, a supply module 104 fluidly coupled to upstream end 106 of the battery compartment, and return module 202 fluidly coupled to downstream and 108 of the battery compartment. Valves 122 and 124 of battery package 100 are not shown in battery package 225, but can nonetheless be included if needed. The primary difference between battery packages 200 and 225 is that in battery package 225 supply module 104 and return module 202 service multiple parallel battery compartments 102. In battery package 200 there is a one-to-one correspondence between battery compartments and supply/return modules, but that that need not be the case in every embodiment. In battery package 225 there is a many-to-one correspondence between battery compartments and supply/return modules. In the illustrated embodiment, supply module 104 and return module 202 service two parallel battery compartments, but in other embodiments a single pair of supply/return modules can service more battery compartments than shown. Battery package 200 operates in substantially the same way as battery package 225.

FIG. 2C illustrates an embodiment of a battery package 275. Battery package 275 is a grouping of individual battery packages in parallel and in series: it includes two parallel rows of modules 252a-252b, and each row 252a-252b includes two battery packages 254 and 265 connected in series. Thus, row 252a includes battery package 254a upstream of module 256a, while row 252b includes battery package 254b upstream of battery package 256b. Other embodiments of battery package 250 can, of course, include more or less rows than shown and more or less battery packages in each row than shown. Valves 122 and 124 of battery package 100 are not shown in battery packages 254 and 256, but can nonetheless be included in some or all of the individual battery packages if needed.

In each row 252a-252b, the return module of each upstream battery package is fluidly coupled to the supply module of a corresponding downstream battery package. In the illustrated embodiment, then, row 252a includes battery package 254a fluidly coupled to battery package 256a, and so on for the other rows in the battery package. In the illustrated embodiment, upstream battery packages 254a-254b are in most respects similar to battery package 225 of FIG. 2B, except that return pump P2 is omitted from battery package’s return. Downstream battery packages 256a-256b are in most respects similar to battery package 100. Each downstream battery package 256 has the inlet of its supply module fluidly coupled to the outlet of the return module of a corresponding upstream battery package 254. This embodiment enables the supply module to be integrated between two battery packages.

FIG. 3 illustrates an embodiment of a battery package 300. Battery package 300 includes a grouping of battery packages in parallel and in series, similar to battery package 250. Battery package 300 includes four parallel rows of modules 302a-302d, and each row includes two battery packages 304 and 306 connected in series, with one battery package upstream of the other. Thus, row 302a includes battery package 304a upstream of module 306a, and so on for the other rows 302b-302d. Other embodiments of battery package 300 can, of course, include more or less rows than shown and more or less battery packages in each row than shown. In the illustrated embodiment the return module of each upstream battery package 304 is fluidly coupled to the supply module of downstream module 306.

Upstream battery packages 304 are in most respects similar to battery package 200 (FIG. 2A), except that return pump P2 is omitted from the return module and valve 122 is repositioned at the inlet of the supply module (i.e., the inlet of pump P1). Downstream battery packages 306 are in most respects similar to battery package 100, except that they include valve 124 at the downstream end of the battery compartment but not valve 122 at the upstream end. As in battery package 250, each downstream module 306 has the input of its supply module fluidly coupled to the output of the return module of a corresponding upstream battery package 304. This embodiment enables the supply module to be integrated between two battery packages.

The rows 302 of battery packages are positioned within a housing 308, and housing 308 has formed within it a pair of fluid channels 310 and 312; channel 310 is a fluid supply channel and channel 312 is a fluid return channel. The inlet of each row 302 —i.e., the inlet of the supply module of each battery package 304 —is fluidly coupled by a valve 122 to supply channel 310. Similarly, the outlet of each row 302 —i.e., the downstream end of each battery package 306—is fluidly coupled by a valve 124 to return channel 312.

In this configuration, fluid flowing from outside housing 308 into supply channel 310 is drawn into the battery package rows 302, proceeds in series through the battery packages 304 and 306 in each row, and exits into return channel 312, where it leaves housing 308. In one embodiment, housing 308 can be partially or fully submerged in an immersion cooling fluid (see FIGS. 4A-4B and 5), so that the immersion cooling fluid is directed along the fluid path indicated by the dashed arrow. The illustrated embodiment shows that the solution can be expanded according to different actual design and operation requirements. This may enable interoperability and scalabilities. In an embodiment, channels 310 and 312 can include fluid connectors not shown. Battery package 300 can be used in embodiments of battery cooling systems such as cooling systems 400 and 500 described below. In one embodiment where battery package 300 is used in systems 400 or 500, for instance, battery package 300 can be inserted into battery space 408, with supply channel 310 fluidly coupled to container supply channel 404 and return channel 312 fluidly coupled to container return channel 406. In another embodiment, battery package 300 can be inserted into container 402, with supply channel 310 replacing container supply channel 404 and return channel 312 replacing container return channel 406.

FIGS. 4A-4B together illustrate an embodiment of a battery cooling system 400. FIG. 4A is a top view, FIG. 4B a sectional side view taken substantially along section line B-B in FIG. 4A. Cooling system 400 is based on an immersion tank design with a container 402 that is designed to be partially or fully immersed in an immersion cooling fluid and to circulate the immersion cooling fluid through battery packages. In some embodiments, container 402 can be integrally formed as part of an IT enclosure such as an IT rack, in particular as a part of the section of the rack designed to hold an immersion cooling fluid. System 400 includes a container supply channel 404 and a container return channel 406 positioned on opposite sides of container 402. Channels 404 and 406 can help to accelerate the flow into and through battery packages. In between channels 404 and 406 is a battery space 408 that can accommodate one or more battery packages 410. Three battery packages 410a-410c are shown in this embodiment, but cooling system 400 can contain any number of battery packages. In one embodiment, battery packages 410a-410c are arranged adjacent to each other and a flow direction of coolant in the battery packages 410 is perpendicular to a flow direction of coolant in channels 404 and 406. In the illustrated embodiment battery packages 410 are configured similarly to battery package 100 (see FIGS. 1A-1C), except that valve 122 is positioned at the inlet of the supply module. In other embodiments battery packages 410 can be configured differently (see, e.g., FIGS. 2A-2C and 3), and is still other embodiments not all battery packages 410 need have the same configuration.

The inlet of each battery package 410—i.e., the inlet of each battery package’s supply module—is fluidly coupled by valve 122 to container supply channel 404. In one embodiment, the inlet of each battery package 410 can be fluidly coupled to supply channel 404 with hardware such as flexible fluid lines 420 and fluid connectors 422 (see FIG. 4B), but other embodiments can accomplish the fluid couplings differently. Similarly, the outlet of each battery package 410—i.e., each battery package’s downstream end—is fluidly coupled by valve 124 to container return channel 406. In the illustrated embodiment, fluid flowing from outside housing 308 into container supply channel 404 is drawn into and through battery packages 410, proceeds through the battery packages, and exits into container return channel 406, where it leaves housing 402 through outlet 418.

Cooling system 400 includes a battery space pump 412 to push and circulate an immersion cooling fluid through battery space 408, so that immersion coolant can enter battery space 408 and the interior of battery packages 410 from supply line 413 and exit or be pushed out through return line 416. Battery space pump 412 can be used to manage and circulate the immersion cooling fluid within the container 402 and can provide a proper thermal environment to store battery cells and/or provide thermal management for a low thermal output/power scenario, such as when battery cells in each battery package 410 are charging. During battery charging, only a minimal amount of heat is generated, and flow of immersion cooling fluid through channels 404 and 406 might not need to be activated. To generate flow of immersion cooling fluid through channels 404 and 406 when needed, cooling system 400 also includes container supply pump 414. Container supply pump 414 can be an external pump that pushes or accelerates immersion cooling fluid in channels 404 and 406 via supply line 415 and pulls fluid out through return line 418. Pump 414, together with pump P1 in each battery package 410, helps circulate immersion cooling fluid through the battery packages and through battery space 408.

During operation, pumps 412 and 414, together with each battery package’s pump P1 and valves 122 and/or 124 (if present), can be used to selectively start, stop, or regulate flow through some or all battery packages. As in battery package 100, each battery package 410 can include a charge/discharge sensor S communicatively coupled to its pump P1, and pump P1 can be electrically coupled to battery cells within the battery package, so that based on input from sensor S each pump P1 can be run with electricity from its battery package, at least during battery discharge.

FIG. 5 illustrates another embodiment of a battery cooling system 500. Cooling system 500 is in most respects similar to cooling system 400: it is based on an immersion tank design with a container 402 that can be integrally formed as part of an IT container such as a rack. Container supply channel 404 and container return channel 406 are positioned on opposite sides of container 402 to help to accelerate the flow into and through battery packages. A battery space 408 can accommodate one or more battery packages 410. Seven battery packages 410a-410g are shown in the illustrated embodiment, but of course other embodiments can include more or less battery packages 410 than shown.

The primary difference between systems 400 and 500 is that system 500 includes additional elements—in this embodiment sensors, controllers, and a power bus—to better control cooling and enable a more robust operation of the overall system. Each individual battery package can still control itself, but system 500 includes system controls in addition to or instead of the individual controls in each battery package. System 500 includes a power bus 502 that is electrically coupled to the battery cells in some or all battery packages 410 and is also electrically coupled to a main power supply such as an electrical utility 504. System 500 also include a dedicated central power unit C, which in one embodiment can also be a battery package in container 502. Central power unit C is electrically coupled to power bus 502 and electrically and communicatively coupled to pump P1 of every battery package 410, so that it can direct the flow of electricity between the power bus and pumps P1 and can selectively activate, deactivate, or regulate individual pumps. In addition, each individual battery package 410 can include a charge/discharge sensor S and a temperature sensor T, both communicatively coupled to their corresponding pump P1 and able to control its individual operation, as discussed above. In battery packages with valves 122 and 124 (not shown in this figure, but see, e.g., FIGS. 1A-1C) at their inlet, outlet, or both inlet and outlet, charge/discharge sensor S and temperature sensor T can both be communicatively coupled to their corresponding valves or valves to control their operation.

In operation of system 500, when battery cells in battery packages 410 are idle-that is, neither charging nor discharging—there is no need for cooling. During battery charging, electricity from utility 504 flows into power bus 502 and from power bus 502 into the battery cells, thus charging the battery cells, generating heat, and requiring cooling. Central power controller C, which is coupled to pumps P1 in all battery packages 410, can direct power to all pumps P1, or to less than all of them if not all battery packages are being charged. During battery discharge electricity from battery cells in battery packages 410 flow into power bus 502, and from the power bus to other IT components (not shown) that require power from the batteries. This discharging of the battery cells also generates heat and requires cooling. Central power controller C, which is coupled to pumps P1 in all battery packages 410, can direct some or all of the power from power bus 502 to some or all of pumps P1, so that each running pump P1 is run at least in part with electricity from its own battery package.

FIG. 6 illustrates an embodiment of a process 600 for operating system 500. At block 602 charge/discharge sensor S and a temperature sensor T are included in each battery package (see FIGS. 1A-1C). At block 604, based on input from charge/discharge sensor S and temperature sensor T, each battery package’s controller individually controls cooling of the battery cells within the battery package by controlling the battery packages pumps and valves—pump P1, pump P2 if present, and also valves 122 or 124 if present (see, e.g., FIGS. 1A-1C). At block 606, when the battery cells within the battery package are discharging, whatever pump and valves are present are also managed to control the cooling delivered to the battery cells. At block 608, during cooling the supply module forms an active channel that delivers immersion cooling fluid into the battery compartment and through the battery cells. At block 610, temperature sensors T are used to control the power to the pump in each module, and at block 612 the fluid flow rate within the battery package can be adjusted as needed based on the temperature obtained at block 610.

Other embodiments are possible besides the ones described above. For instance:
The internal packaging and arrangement of cells in a battery package can be in different, such as in different series and parallel arrangements.
The hardware design of the acceleration port or opening can be in different.
The system enclosure maybe designed in different configurations.

The above description of embodiments is not intended to be exhaustive or to limit the invention to the described forms. Specific embodiments of, and examples for, the invention are described herein for illustrative purposes, but various modifications are possible.

What is claimed is:

1. A battery package comprising:
one or more battery compartments each having an upstream end, a downstream end, and a plurality of sidewalls extending between the upstream end and the downstream end, each battery compartment having a plurality of battery cells disposed therein; and
a supply module fluidly coupled to the upstream end of the one or more battery compartments, the supply module including:
a supply pump having an inlet and an outlet, and
a supply flow channel that fluidly couples the outlet of the supply pump to the upstream ends of the one or more battery compartments.

2. The battery package of claim 1, further comprising:
a supply valve fluidly coupled to the inlet or the outlet of the supply pump;
a return valve positioned at the downstream end of the one or more battery compartments; or
a supply valve fluidly coupled to the inlet or the outlet of the supply pump and a return valve positioned at downstream end of the one or more battery compartments.

3. The battery package of claim 1 wherein the supply flow channel is a diverging flow channel.

4. The battery package of claim 1, further comprising a return module including a return flow channel fluidly coupled to the downstream ends of the one or more battery compartments.

5. The battery package of claim 4, wherein the return module further comprises a return pump having an inlet and an outlet, the inlet of the return pump being fluidly coupled to the return flow channel.

6. The battery package of claim 4 wherein the return flow channel is a converging channel.

7. The battery package of claim 4, further comprising:
one or more additional battery compartments each having an upstream end, a downstream end, and a plurality of sidewalls extending between the upstream end and the downstream end, each additional battery compartment having a plurality of battery cells disposed therein; and
an additional supply module fluidly coupled to the upstream end of each additional battery compartment.

8. The battery package of claim 7, wherein the additional supply module comprises:
a supply pump having an inlet and an outlet; and
a supply flow channel that fluidly couples the outlet of the supply pump to the upstream ends of the one or more additional battery compartments;
wherein the inlet of the supply pump of the additional supply module is fluidly coupled to an outlet of the return flow channel.

9. The battery package of claim 1, further comprising:
an electrical bus electrically coupled to the plurality of battery cells and communicatively coupled to the supply pump;
a charge/discharge sensor coupled to the electrical bus to sense when the plurality of battery cells are charging or discharging;
a controller electrically coupled to the charge/discharge sensor and the supply pump, wherein the controller can direct electricity from the electrical bus to the supply pump when the plurality of battery cells is charging or discharging.

10. The battery package of claim 1, further comprising:
a temperature sensor positioned at or near the downstream ends of the one or more battery compartments; and
a controller electrically coupled to the temperature sensor and the supply pump, wherein the controller can regulate the speed of the supply pump based on the temperature sensed by the temperature sensor.

11. A battery cooling system comprising:
a container including a container supply channel, a container return channel, and a battery space;
one or more battery packages positioned in the battery space, each battery package comprising:
one or more battery compartments each having an upstream end, a downstream end, and a plurality of sidewalls extending between the upstream end and the downstream end, each battery compartment having a plurality of battery cells disposed therein; and
a supply module fluidly coupled to the upstream end of the one or more battery compartments, the supply module including:
a supply pump having an inlet and an outlet, and
a supply flow channel that fluidly couples the outlet of the supply pump to the upstream ends of the one or more battery compartments;
wherein the inlet of each supply pump is fluidly coupled to the container supply channel and the downstream ends of the one or more battery compartments are fluidly coupled to the container return channel.

12. The battery cooling system of claim 11, wherein each battery package further comprises:
a supply valve fluidly coupled to the inlet or the outlet of the supply pump;
a return valve positioned at the downstream end of the one or more battery compartments; or
a supply valve fluidly coupled to the inlet or the outlet of the supply pump and a return valve positioned at downstream end of the one or more battery compartments.

13. The battery cooling system of claim 11 wherein each battery package further comprises a return module, the return module including a return flow channel fluidly coupled to the downstream ends of the one or more battery compartments, wherein the downstream ends of the one or more battery compartments are fluidly coupled by the return flow channel to the container return channel.

14. The battery cooling system of claim 13 wherein each return module further comprises a return pump having an inlet and an outlet, the inlet of the return pump being fluidly coupled to the return flow channel and the outlet of the return pump being fluidly coupled to the container return channel.

15. The battery cooling system of claim 11, further comprising a container power bus electrically coupled to a utility and to the battery cells and the supply pumps of the one or more battery packages.

16. The battery cooling system of claim 15, further comprising a central power unit electrically coupled to the container power bus and communicatively coupled to the supply pumps of the one or more battery packages, wherein the central power unit is adapted to:
cause the battery cells to deliver electrical power to the container power bus when the battery cells are discharging and cause the utility to deliver electrical power to the container power bus when the battery cells are charging, and
selectively activate, deactivate, or regulate the supply pump of at least one of the one or more battery packages.

17. The battery cooling system of claim 11 wherein each battery package further comprises:
an electrical bus electrically coupled to the plurality of battery cells and communicatively coupled to the supply pump;
a charge/discharge sensor coupled to the electrical bus to sense when the plurality of battery cells are charging or discharging;
a controller electrically coupled to the charge/discharge sensor and the supply pump, wherein the controller can direct electricity from the electrical bus to the supply pump when the plurality of battery cells is charging or discharging.

18. The battery cooling system of claim 11 wherein each battery package further comprises:
a temperature sensor positioned at or near the downstream ends of the one or more battery compartments; and
a controller electrically coupled to the temperature sensor and the supply pump, wherein the controller can regulate the speed of the supply pump based on the temperature sensed by the temperature sensor.

19. The battery cooling system of claim 11, further comprising:
a battery space pump to push cooling fluid into the battery space; and
a battery space outlet to pull cooling fluid from the battery space.

20. The battery cooling system of claim 19, further comprising:
a container supply pump to push cooling fluid into the container supply channel; and
a return channel outlet to pull cooling fluid from the return channel.
